(19) United States
(12) Patent Application Publication
(10) Pub. No.: US 2017/0261198 A1
(43) Pub. Date: Sep. 14, 2017

(54) Lamp for use with computers

(71) Applicant: Glowzi, LLC, Miami, FL (US)

(72) Inventors: Ian Shiell, Boynton Beach, FL (US); Henry Geddes, Delray Beach, FL (US)

(73) Assignee: Glowzi, LLC

(21) Appl. No.: 15/063,591

(22) Filed: Mar. 8, 2016

(51) Int. Cl. F21V 33/00; F21V 11/16; H04N 7/14; F21V 23/04; F21V 23/02; H04N 5/225; G03B 15/02; F21V 14/02

(52) U.S. Cl. CPC F21V 33/0052; G03B 15/02; F21V 11/16; F21V 14/02; F21V 23/04; F21V 23/02; H04N 5/2256; H04N 7/142; F21Y 2103/10

(57) ABSTRACT

A lamp for use with a computer, including cell phones and pads, comprises a body having a slot formed along its length for engaging the computer, by slipping over the edge of the computer's screen. The lamp includes a translucent cylinder, rotatably supported on the lamp body and supporting a parallel string of LEDs. A portion of the cylinder has an opaque cover so that the direction and intensity of the light cast by the lamp may be adjusted by rotating the cylinder.

### FIELD OF THE INVENTION

This invention relates to lamps for attachment to computers to aid in videoconferencing and general use of the computers.

### BACKGROUND OF THE INVENTION

Almost all modern computers, including cell phones and pads, include a camera which faces the user and may be employed for general static or video recording purposes, such as video conferencing via a network with other computers, or to take “selfies”, which are photographs of the computer user. Often the illumination in an area in which such a computer is being used to take photographs is not sufficient to generate a clear picture of the subject. Also, apart from photography, the ambient brightness may not be sufficient to light up keyboards on the computers, or video books, or videos being played on the computer.

### SUMMARY OF THE INVENTION

The present invention is therefore directed toward a lamp adapted to be supported on almost any type of computer, to provide the brightness necessary for photography as well as other uses.

The computer lamp of the present invention preferably is formed with a body member including an electrically powered illumination source and a configuration adapted to allow the body to be attached to almost any form of computer in such a manner as to provide the needed illumination.

In a preferred embodiment of the invention a body member has an elongated slot extending across its length, of a width allowing it to engage the opposed sides of an edge of the computer body surrounding the display screen. The lamp body member is preferably formed of plastic and the sides of the slot are lined with layers of a resilient material. The resilient layer may be rubber or the like and the two opposed sides of the slot extend from the lamp body as two thin, opposed layers of plastic. This combination gives the slot a resilience so it may grip computers having a slight variation in the thickness of their edges.

The illumination source for the lamp preferably takes the form of an elongated transparent or translucent, hollow cylinder supporting a string of LEDs. The LEDs may be of differing colors such as white and light yellow arrayed in alternating forms to project a relatively pure white light. The cylinder is rotatably supported in the body, parallel to the extension of the slot, and has rotatable connections at its opposed ends which engage the opposed polarity terminals of an electrical power source. The cylinder is supported from projecting end sections of the lamp body which support the cylinder so that it extends orthogonally to the slot on the lamp body, over the top of the computer frame so that the lamp projects light over the front of the display section of the computer.

Preferably the power source is a rechargeable battery. A socket on the body allows the battery to be recharged from a USB port on a computer or a 110 volt wall plug.

The cylindrical illumination support is preferably covered by a shade which extends the length of the cylinder and covers approximately half of the periphery of the cylinder. By rotating the cylinder, the user can control the area the light is projected to and the degree of illumination. The body also preferably supports a manual power switch in the circuit for the LEDs which has one position for full illumination and a second position for a dimmer illumination.

### BRIEF DESCRIPTION OF THE DRAWINGS

Other objectives, advantages, and applications of the present application will be made apparent by the following detailed description of a preferred embodiment. The description makes reference to the accompanying drawings in which:

FIG. 1 is a perspective view of a user holding a computer pad with the illumination lamp of the present invention attached to the top of the pad;

FIG. 2 is a perspective view of a preferred embodiment of the illumination lamp taken from the top right, with a section of the lamp body broken away to show one of the rotary connectors for the cylindrical illumination section;

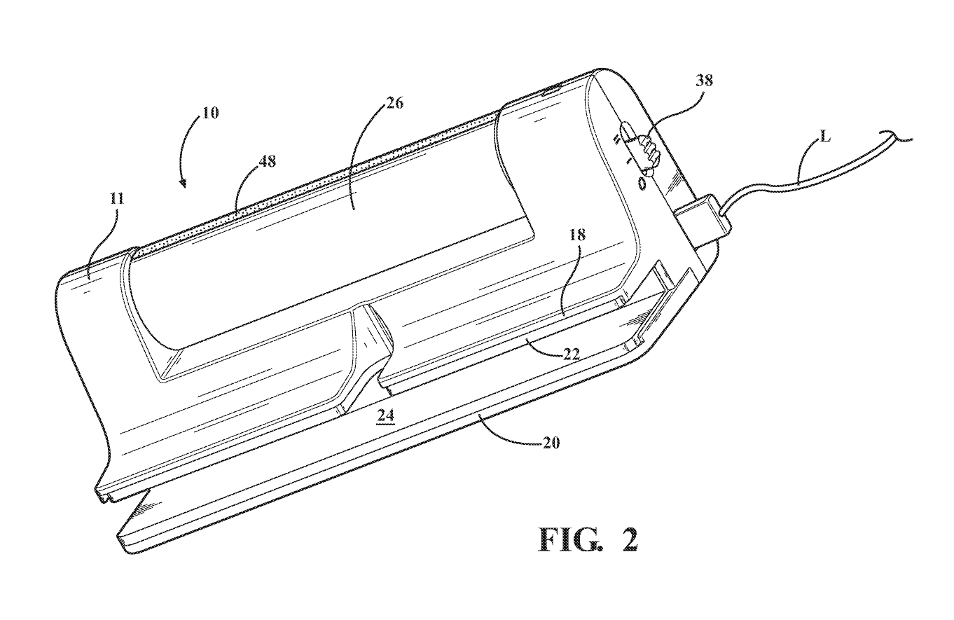

FIG. 3 is a perspective view of a preferred embodiment of the illumination lamp from a side;

FIG. 4 is a front view of the illumination lamp of the present invention;

FIG. 5 is a top view of the illumination lamp of the present invention with the cylindrical section broken away to illustrate the LED string;

FIG. 6 is a bottom view of the illumination lamp of the present invention; and

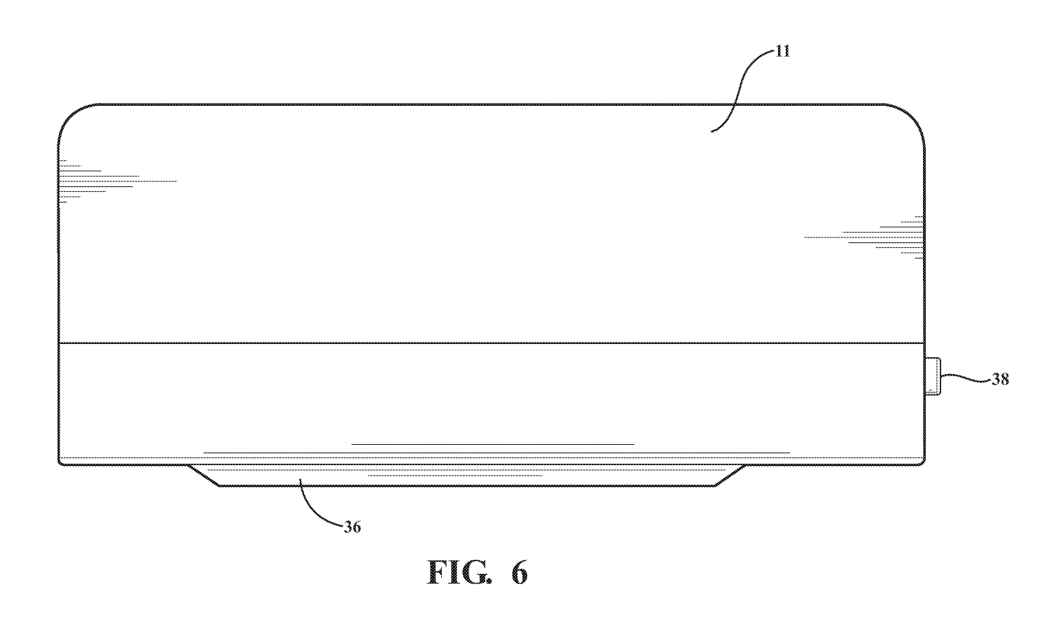

FIG. 7 is an end view of the illumination lamp of the present invention from the side bearing the switch showing the slot in the lamp body engaging an edge of a computer screen.

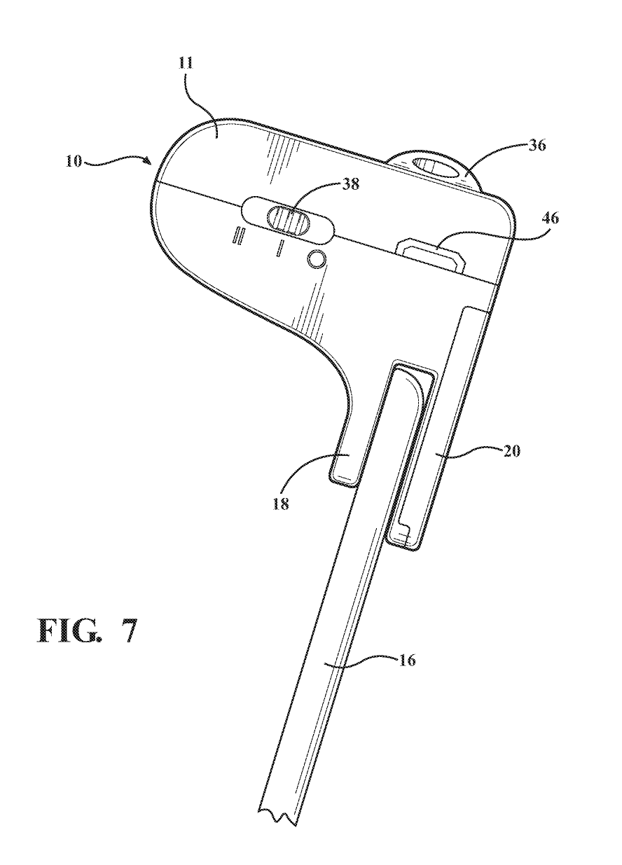

### DETAILED DESCRIPTION OF THE PREFERRED EMBODIMENTS

As illustrated in the figures, a preferred embodiment of the computer lamp, generally indicated at 10, may be secured to a computer taking the form of a pad 12, by sliding a slot, generally indicated by 14, formed on the bottom side of the lamp body 11, by extending edges 18 and 20 of a lamp body 24 over an edge 16 of the frame of the pad. Most computers, cell phones, computer pads, and the like have a similar display thickness and the flexibility of the sections 18 and 20 forming the slot 14 will allow it to be supported on a large majority of these computing devices.

The opposed interior surfaces of the slot 14 are covered by thin sections of resilient material 22 and 24, such as rubber or another elastic polymeric substance having similar properties of resiliency. The sections 18 and 20, forming the slot 14, project orthogonally to the main lamp member 26, so that when the slot is supported over a computer section like 16, the lamp 26 projects outwardly toward the viewer.

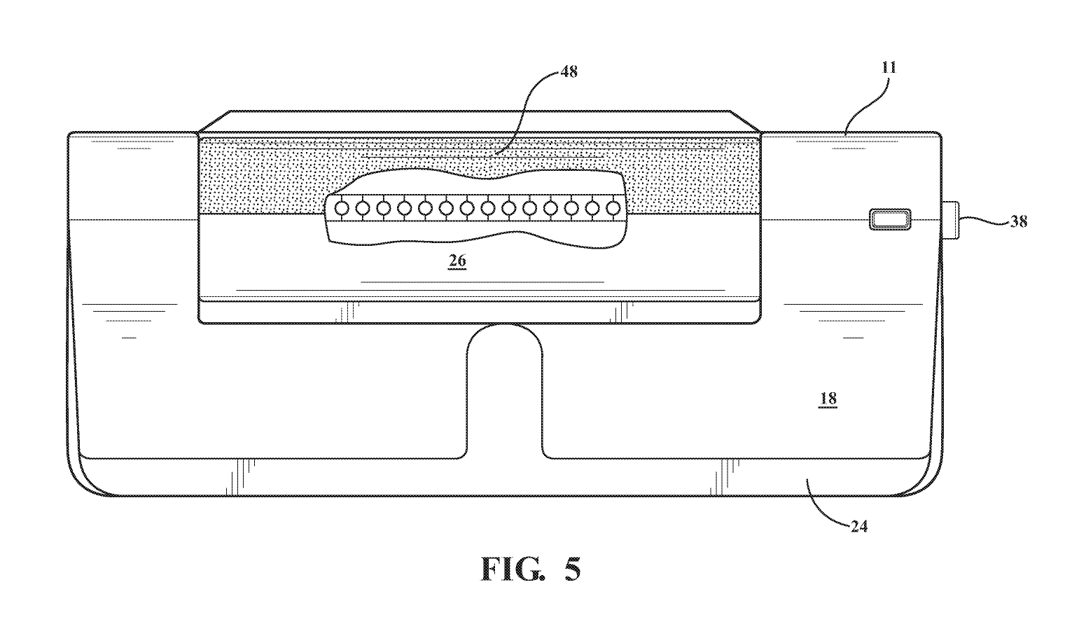

The lamp cylinder cover is formed of a translucent plastic which constitutes the illumination source. As shown in the broken away section of the cylindrical cover 26 in FIG. 5, the illumination source consists of a plurality of LEDs 28 connected in parallel across a pair of direct current power lines 30 and 32. The LEDs 28 may include units projecting different colors, such as white and light yellow, alternating with one another so as to provide a projection of a relatively pure white light.

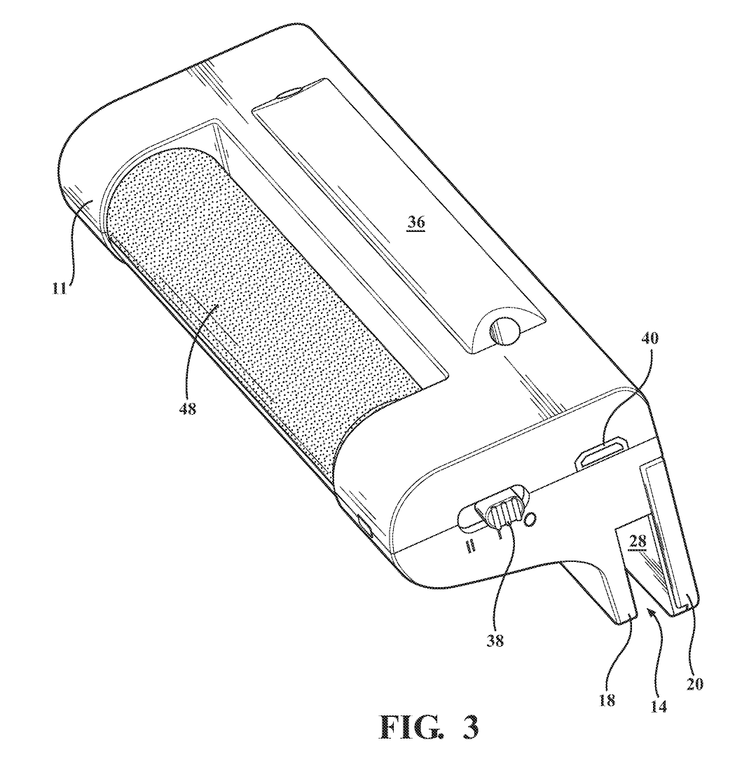

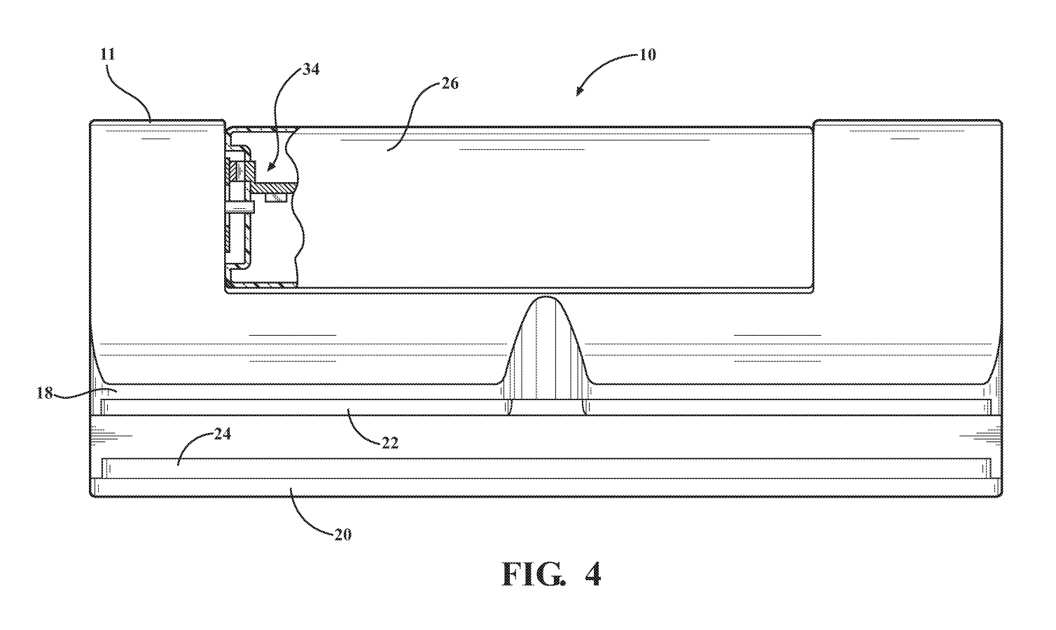

As shown in the broken section on FIG. 4, the opposed ends of the cylinder 26 are supported by rotary connectors 34 which allow the cylinder 26 to rotate about its central axis and continue making contact with a power supply for the conductors 30 and 32. This rotatable connection may be of the type generally shown in class 439, subclass 121 of the U.S. classification system. The LEDs 28 may be powered by rechargeable batteries stored within a holder 36 on the back of the body member. The voltage level provided by the battery to the LEDs 28 may be switched between a relatively high voltage and a lower voltage by a switch 38 supported on the side of the body 24 as shown in FIG. 3. The batteries may be rechargeable through a USB port 40 which receives a USB male connector 42 connected to a power cord 40. The other end of the cord may be connected into a USB portion of the computer 12 or a 110 volt wall socket through an appropriate AC to DC power converter 46.

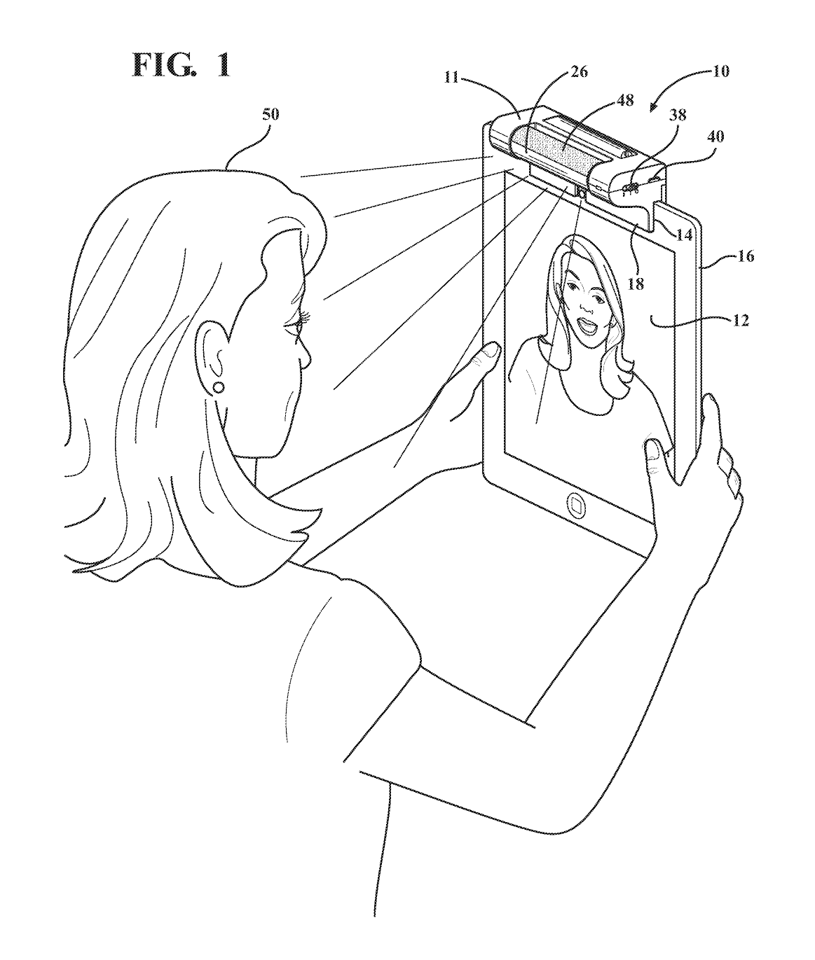

As shown in the figures, one side of the illumination cover 26 is coated with an opaque layer 48 which extends along one longitudinal side of the cylinder 26 to block light passing through that section. Thus, the user may rotate the section 26 about the rotatable end connections 34 to control the direction and relative intensity of the illumination of the lamp. The lamp thus may be used to illuminate the operator of the computer 50 as illustrated in FIG. 1 for purposes of taking “selfies” or for video conferencing or the like, or the keyboard or other parts of a computer which require illumination, or such as electronic books or videos.

Having thus described our invention we claim:

1. A lamp for illuminating a subject being photographed by a camera having an edge, comprising:
a body member having an elongated open-ended slot adapted to fit over the edge of the camera so that the opposed interior edges of the slot engage opposed sides of the camera edge to support the lamp on the camera;
an elongated light source having a pair of opposed ends and having a transparent cover, rotatably supported on the body member; and
an electric power supply for the light source having terminals connected to the opposed ends of the light source.

2. The lamp of claim 1 wherein the camera is a component of a computer.

3. The lamp of claim 2 wherein the cover for the light source is cylindrical.

4. The lamp of claim 2 wherein the electric power supply is connected to the light source by rotatable couplings.

5. The lamp of claim 2 wherein the light source is supported on the body member parallel to said slot.

6. The lamp of claim 5 wherein the light source is supported on the body member so as to project orthogonally to the longitudinal extension of the slot to extend over the front of the computer.

7. The lamp of claim 1 wherein the elongated light source comprises a plurality of light emitting diodes.

8. The lamp of claim 7 wherein the light emitting diodes include diodes which are of differing wavelengths interspersing with one another.

9. The lamp of claim 3, further comprising an opaque shade covering a longitudinal section of the cylindrical light source cover so that rotation of the light source relative to the body member adjusts the illumination of the subject being photographed.

10. The lamp of claim 1 wherein the power supply for the light source has a plurality of power outputs selectable by a manually adjustable switch supported on the body member.

11. The lamp of claim 1 wherein the camera is digital and connectable to the Internet.

12. The lamp of claim 1 wherein the subject being photographed is a person holding a computer having the lamp supported thereon.

13. A lamp for illuminating a subject being photographed by a camera having an edge, comprising:
a body member;
an elongated light source having a pair of opposed ends and having a transparent cover, rotatably supported on the body member; and
an electric power supply for the light source having terminals connected to the opposed ends of the light source.

14. The lamp of claim 13 wherein the cover for the light source is cylindrical.

15. The lamp of claim 13 wherein the electric power supply is connected to the light source by a rotatable coupling.

16. The lamp of claim 13 wherein the elongated light source comprises a plurality of light emitting diodes.

17. The lamp of claim 16 wherein the light emitting diodes include diodes which are of differing wavelengths interspersing with one another.

18. The lamp of claim 14, further comprising an opaque shade covering a longitudinal section of the cylindrical light source cover so that rotation of the light source relative to the body member adjusts the illumination of the subject being photographed.
